(19) United States
(12) Patent Application Publication
(10) Pub. No.: US 2025/0211606 A1
(43) Pub. Date: Jun. 26, 2025

(54) AUGMENTATION OF NETWORK PATH VISUALIZATIONS WITH VULNERABILITY INFORMATION

(71) Applicant: Cisco Technology, Inc., San Jose, CA (US)

(72) Inventors: David John ZACKS, Vancouver (CA); Indermeet Singh GANDHI, San Jose, CA (US); Hans ASHLOCK, Berkeley, CA (US)

(21) Appl. No.: 18/390,682

(22) Filed: Dec. 20, 2023

(51) Int. Cl. H04L 9/40

(52) U.S. Cl. CPC H04L 63/1433; H04L 63/1416; H04L 63/1425

(57) ABSTRACT

In one implementation, a method is disclosed comprising: initiating probing of a path in a network by sending one or more probe packets along the path, wherein each hop along the path responds with vulnerability score information for that hop; receiving modified responses containing the vulnerability score information for each hop along the path; generating, based on the modified responses, a visual representation of the path that identifies vulnerability scores associated with each hop along the path; and providing the visual representation to a user interface for display.

### TECHNICAL FIELD

The present disclosure relates generally to computer systems, and, more particularly, to augmentation of network path visualizations with vulnerability information.

### BACKGROUND

Traditionally, path probing has allowed network administrators and route selection mechanisms to assess the performance of the various network paths that are available to a given destination, such as the loss, latency, or jitter along a given path. To do so, path probing entails sending probe packets along the target paths, to record information such as whether the packet reached its destination, how long it took for the packet to traverse the path and/or each hop along the path, etc.

While performance is certainly a consideration when choosing a network path, other factors are also largely ignored, such as the security risk or vulnerability to security threats associated with a path and/or its constituent hops. Presently, there is no mechanism to achieve comprehensive visibility of vulnerabilities across these paths and their components, thereby constraining risk-based routing decisions. Instead, traffic routing operates with a large blind spot regarding vulnerabilities existing throughout the network. These unidentified vulnerabilities can be exploited, leading to data breaches, service disruptions, and unauthorized access to sensitive information. As a consequence, network security measures are primarily reactive and geared toward earlier recognition and addressment of a breach rather than forestalling breaches before they occur.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example of an architecture of a probing system for intelligent network path probing;

FIG. 5 illustrates an example an architecture for augmentation of network path visualizations with vulnerability information; and

FIG. 6 illustrates an example of a simplified procedure for augmentation of network path visualizations with vulnerability information in accordance with one or more implementations described herein.

### DESCRIPTION OF EXAMPLE EMBODIMENTS

### Overview

According to one or more implementations of the disclosure, a device may initiate a probing of a path in a network by sending one or more probe packets along the path. Each hop along the path responds with vulnerability score information for that hop. The device may receive modified responses containing the vulnerability score information for each hop along the path and generate, based on the modified responses, a visual representation of the path that identifies vulnerability scores associated with each hop along the path. The device may provide the visual representation to a user interface for display.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

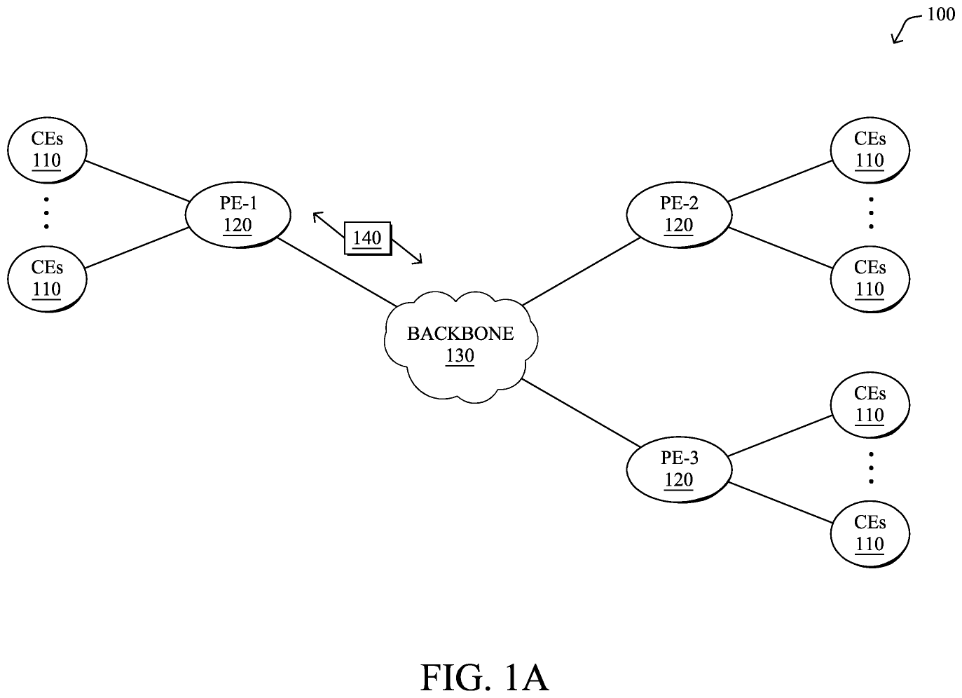

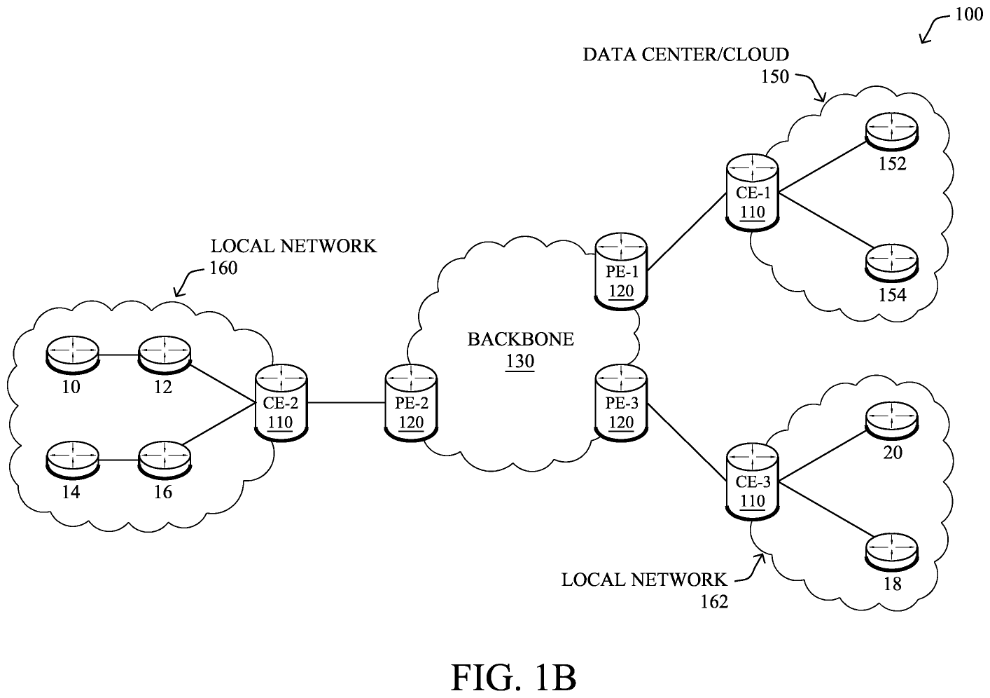

FIG. 1A is a schematic block diagram of an example computer network (e.g., network 100) illustratively comprising nodes/devices, such as a plurality of routers/devices interconnected by links or networks, as shown. For example, customer edge (CE) routers (e.g., CE routers 110) may be interconnected with provider edge (PE) routers 120 (e.g., PE-1, PE-2, and PE-3) in order to communicate across a core network, such as an illustrative network backbone (e.g., network backbone 130). For example, routers (e.g., CE routers 110), routers 120 may be interconnected by the public Internet, a multiprotocol label switching (MPLS) virtual private network (VPN), or the like. Data packets 140 (e.g., traffic/messages) may be exchanged among the nodes/devices of the network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router (e.g., CE routers 110) shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., CE routers 110) connected to PE-2 and a second CE router (e.g., CE routers 110) connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks (e.g., network 160-162) that include devices/nodes 10-16 and devices/nodes 18-20, respectively, as well as a data center/cloud environment 150 that includes servers 152-154. Notably, local networks (e.g., network 160-162) and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

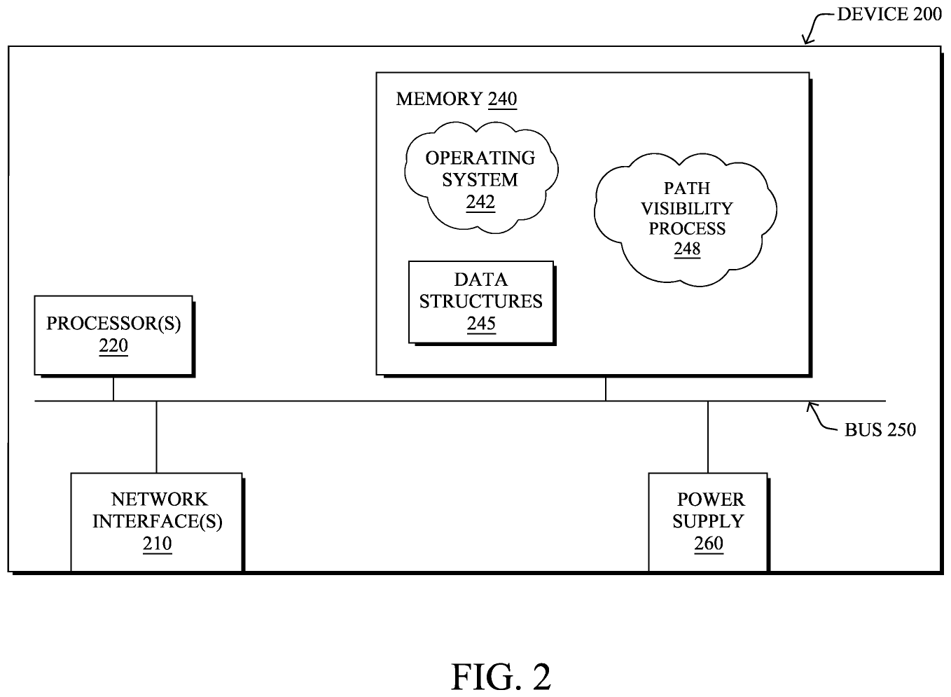

FIG. 2 is a schematic block diagram of an example node/device 200 (e.g., an apparatus) that may be used with one or more implementations described herein, e.g., as any of the computing devices shown in FIGS. 1A-1B, particularly the PE routers (e.g., routers 120), CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces (e.g., network interfaces 210), one or more processors (e.g., processor(s) 220), and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor (e.g., processor(s) 220) may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a path visibility process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In some instances, path visibility process 248 may include computer executable instructions executed by the processor (e.g., processor(s) 220) to establishing network path visibility using an intelligent network path probing technique and/or to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, path visibility process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, path visibility process 248 may include computer executable instructions that, when executed by processor(s) 220, cause device 200 to perform the techniques described herein. To do so, in some implementations, path visibility process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, path visibility process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the path visibility process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further embodiments, path visibility process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, path visibility process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact on the overall Internet due to the extreme virtualization of services and shift of traffic load in many large enterprises. Consequently, a branch office or a campus can trigger massive loads on the network.

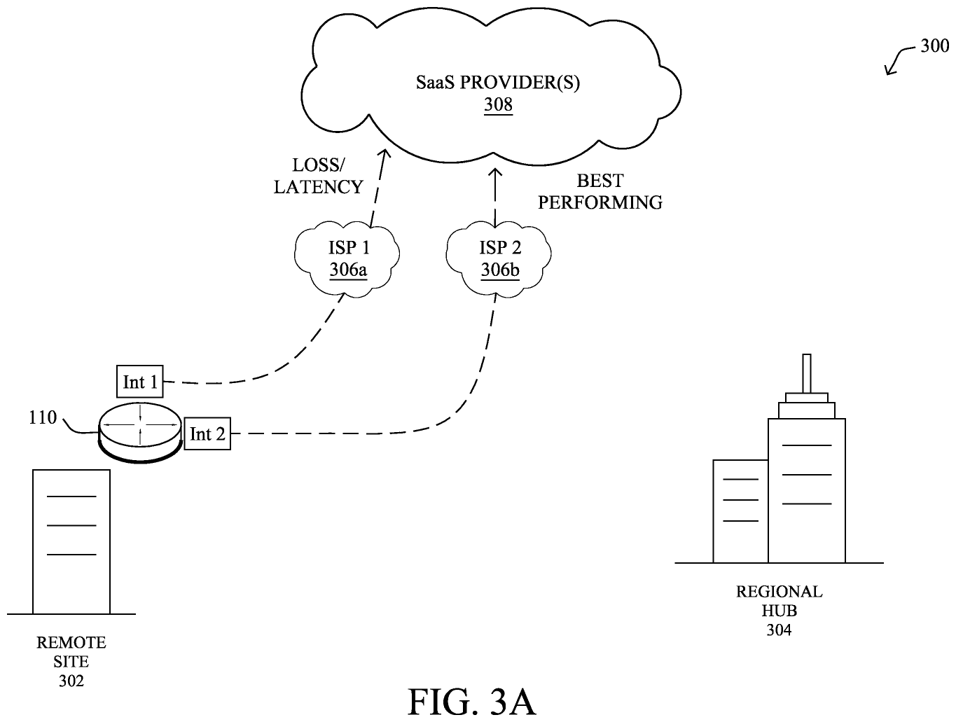

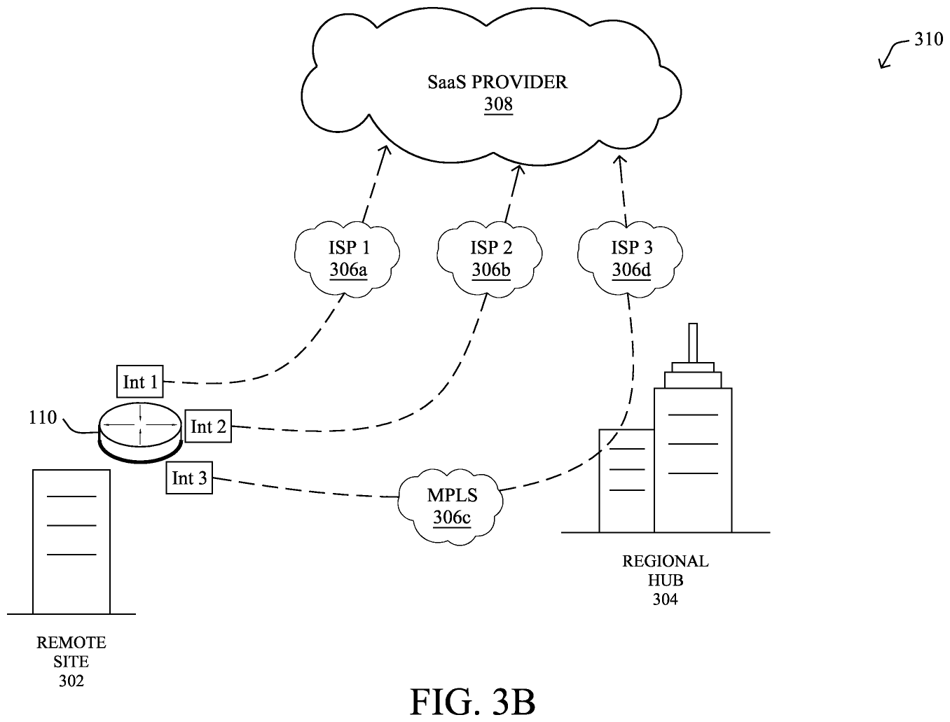

FIGS. 3A-3B illustrate examples of network deployments 300, 310, respectively. As shown, a router (e.g., CE routers 110) located at the edge of a remote site 302 may provide connectivity between a local area network (LAN) of the remote site 302 and one or more cloud-based, SaaS providers (e.g., provider(s) 308). For example, in the case of an SD-WAN, router (e.g., CE routers 110) may provide connectivity to SaaS provider(s) (e.g., provider(s) 308) via tunnels across any number of networks 306. This allows clients located in the LAN of remote site 302 to access cloud applications (e.g., Office 365™, Dropbox™, etc.) served by SaaS provider(s) (e.g., provider(s) 308).

As would be appreciated, SD-WANs allow for the use of a variety of different pathways between an edge device and a SaaS provider. For example, as shown in example network deployment 300 in FIG. 3A, router (e.g., CE routers 110) may utilize two Direct Internet Access (DIA) connections to connect with SaaS provider(s) 308. More specifically, a first interface of router (e.g., CE routers 110) (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router (e.g., CE routers 110), Int 2, may establish a backhaul path with SaaS provider(s) 308 via a second ISP 306b, denoted ISP 2 in FIG. 3A.

FIG. 3B illustrates another example network deployment 310 in which Int 1 of (e.g., CE routers 110) at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router (e.g., CE routers 110) may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

As noted above, service providers, and enterprises that operate or depend on IP/Internet based networks for critical business need to understand both the paths that their network traffic takes and the performance of those paths. Ideally, network path performance data should identify as many specific IP hops (routers) as possible in the path, and the performance impact of each of those hops/segments on the overall end-to-end performance of a given network connection.

Generally, synthetic network probing techniques are utilized to identify network paths. These techniques generate network traffic from a source to a destination using the same traffic characteristics as the application/services whose performance is sought to be understood. In addition, traceroute-style algorithms may be used to achieve these insights by leveraging the IP packet time to live (TTL) header and TTL Expired Internet Control Message Protocol (ICMP) responses from routers to build hop-by-hop representations of the paths taken by those same synthetic probe packets. In this way, the measured performance of these synthetic packets and the network paths is often assumed to be an accurate approximation of the actual performance and path of the corresponding applications/services.

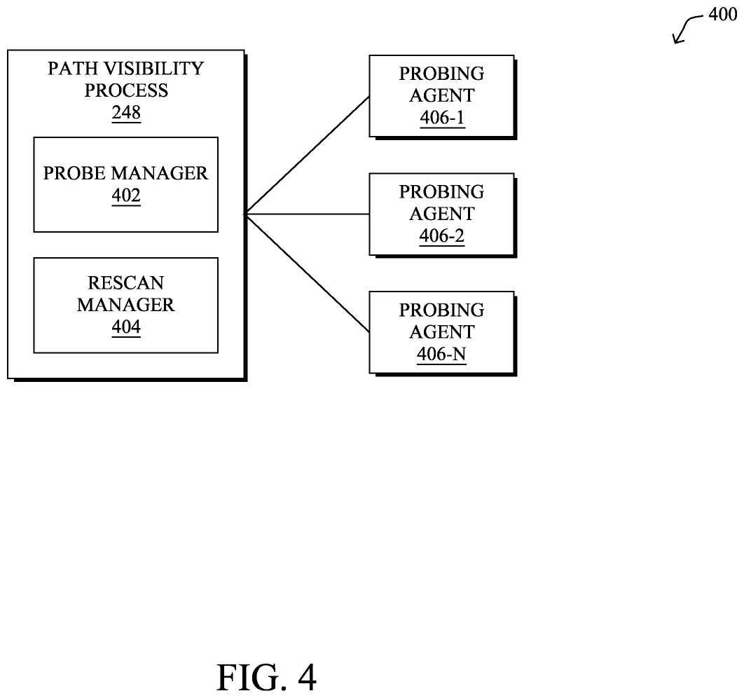

By way of example, FIG. 4 illustrates an example of an architecture 400 of a (synthetic) probing system for intelligent network path probing, according to various implementations. At the core of architecture 400 is path visibility process 248, which may be executed by one or more devices that participate in network path probing, network path data and/or performance metric collection, network routing, a network supervisory service, a network infrastructure monitoring/mapping service, an application delivery troubleshooting service, etc. In various implementations, path visibility process 248 may include instructions executable as part of or in collaboration with a network monitoring SaaS platform which may configure synthetic network path probe protocols and/or configurations, cause a path probing service in the network comprising one or more probing agent (e.g., probing agent 406 (406-1 . . . 406-N)) to generate and/or send those synthetic probes, and/or collect and analyze the data returned by those synthetic probes.

As shown, path visibility process 248 may include probe manager 402 and rescan manager 404. As would be appreciated, the functionalities of these components may be combined or omitted, as desired. In addition, these components may be implemented on a singular device or in a distributed manner, in which case the combination of executing device can be viewed as their own singular device for the purposes of executing path visibility process 248.

During execution of path visibility process 248, probe manager 402 may intelligently select one or more synthetic probe protocols and/or configurations to be used for each probing agent 406 to probe a network path between a particular source-destination pair. Each probing agent 406 may be assigned its own synthetic probe protocol and/or configuration to execute. This may mean that, in some instances, different probing agents receive different probe protocol and/or configuration assignments from one another.

Probe manager 402 may select a synthetic probe protocol and/or configuration to be used by each probing agent 406 to synthetically probe the path between the source and the destination from among probing options available to the synthetic probing system.

The probing options may include different types of packets that can be used by available probing agents to perform path probing between the source and the destination. Some examples may include TCP packets, ICMP packets, UDP packets, IGRP packets, other types of packets, etc. In addition, the probing options may include various configurations that may be applied to those packets under different options (e.g., DSCP markings, etc.). Probe manager 402 may select a portion of and/or all of the synthetic probe protocols and/or configurations available to the synthetic probing system for use by the agents in order to generate multiple diverse perspectives that can be collectively used generate a complete view of the network path.

Once the probe manager 402 has selected the set of synthetic probe protocols and/or configurations that will be used by the probing agent, it will then send each probing agent its respective synthetic probe protocol and/or configuration assignment to perform the initial pre-probe scan. Probe manager 402 may receive the results (e.g., path trace data, etc.) of the probing by each of the probing agents. The probe manager 402 may intelligently combine the probe data from each of the probing agents so that the data from some of the probes can supplement missing data from other probes and the combination minimizes the number of non-responding nodes, provides the most complete and accurate path representation for the path between the source and destination, and/or minimizes the impact of processing delays is reduced.

During execution of path visibility process 248, rescan manager 404 may be responsible for initiating re-scanning/probing of a given path, according to any number of conditions. For example, the probe rescan may be triggered in response to detecting a deterioration in the ability of the existing probes to provide complete and accurate network insights for a path. In some implementations, rescan manager 404 may utilize intelligent automation to detect changes in the network that warrant performing a rescan of probing methods. Detecting the changes in the network may be accomplished by analyzing network and/or application metrics collected from the probes monitoring the network path. For example, the network changes may be detected by comparing the collected network metrics to threshold levels, analyzing the network metrics for trends, detecting changes from prior network metrics, etc. Any comparison threshold used to detect changes and/or its significance may be learned (e.g., using ML techniques, etc.) based on historical probing data and/or path trace results. Rescan manager 404 may analyze the detected changes to determine if they will impact and/or degrade path visibility.

For example, if a particular synthetic network probe has been running from source A to destination B and consistently measuring ten network hops, then suddenly changes to five network hops, rescan manager 404 may detect this change. Rescan manager 404 may determine (e.g., based on comparison with a learned threshold, based on comparison with a default threshold, etc.) that this change signifies a configuration change in the network and/or is of significant enough magnitude to warrant a path rescan to determine if there is a new combination of alternate probing methods that could be used to improve network path visibility for that path going forward.

In further implementations, rescan manager 404 may initiate re-scanning/probing of a given path periodically, in response to a request to do so, or when any other such defined conditions are met. These parameters may also be configurable, in some instances, such as via a user interface operated by an administrator.

As noted above, one key piece of information that is missing from modern path probing and visualization systems relates to vulnerabilities that may be lurking among the hops along a network path. For instance, conventional network monitoring platforms are configured to provide a detailed view of various network elements, such as routers and switches, and their performance metrics, such as latency, packet loss, and jitter. However, these platforms are unable to provide any visibility into the security vulnerabilities existing among individual hops in the path. This can be a significant issue for users who need to assess the security risks associated with different network paths and it forecloses the possibility of informed vulnerability exposure-based routing decisions. This problem may be intensified by most of the hops being under the ownership or control of third parties relative to those sending the traffic, meaning that direct inspection or knowledge of the hops is also not possible.

—Augmentation of Network Path Visualizations with Vulnerability Information—

In contrast, the techniques herein introduce mechanisms to augment network path data with vulnerability scores of network hops without necessarily requiring API or management-level communication with specific/individual network devices. This technique facilitates the augmentation of path knowledge with vulnerability risk assessments. For example, the technique may leverage path probing packets (e.g., ThousandEyes probes, etc.) to facilitate the collection and/or incorporation of common vulnerability scoring system (CVSS) scores, software bill of materials (SBOM) analysis, etc. for each node in the network topology into path definitions, path visualizations, and/or path routing decisions. The resulting path visualizations can offer visibility into security vulnerabilities of individual hops in addition to other detailed network path analytics. As such, this new visibility may be utilized to inform security risk-based routing decisions.

Illustratively, the techniques described herein may be performed by hardware, software, and/or firmware, such as in accordance with the path visibility process 248, which may include computer executable instructions executed by the processor (e.g., processor(s) 220) (or independent processor of interfaces (e.g., network interfaces 210)) to perform functions relating to the techniques described herein.

Specifically, according to one or more implementations of the disclosure as described in detail below, a device initiates probing of a path in a network by sending one or more probe packets along the path, wherein each hop along the path responds with vulnerability score information for that hop. The device receives modified responses containing the vulnerability score information for each hop along the path. The device generates, based on the modified responses, a visual representation of the path that identifies vulnerability scores associated with each hop along the path. The device provides the visual representation to a user interface for display.

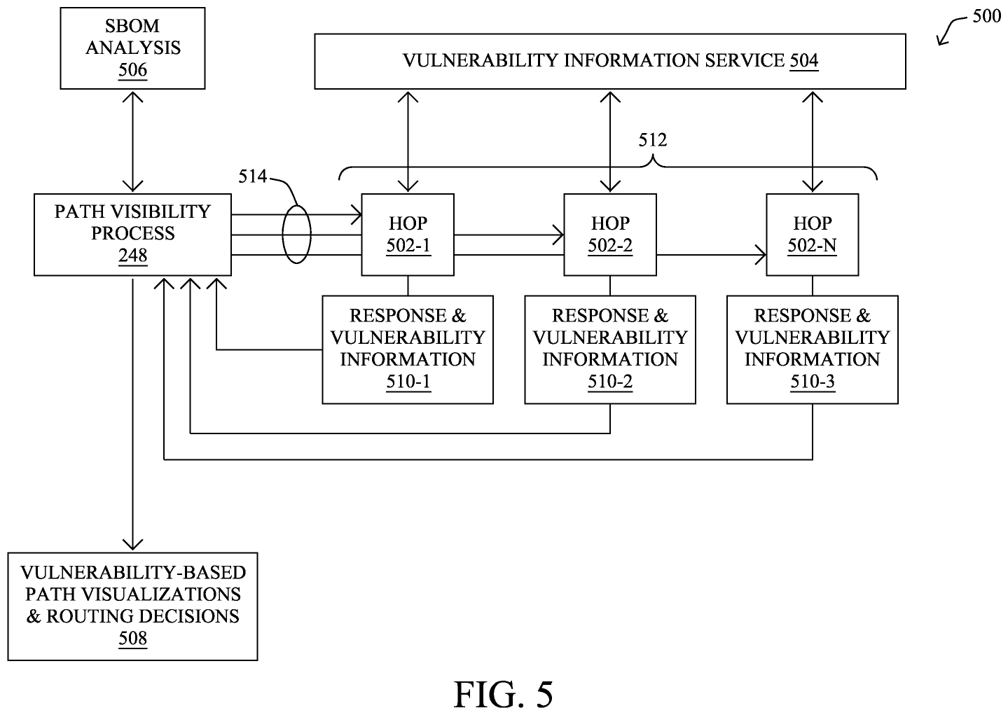

Operationally and according to various implementations, FIG. 5 illustrates an example of an architecture 500 for augmentation of network path visualizations with vulnerability information. For example, architecture 500 includes hops 502 (e.g., 502-1 . . . 502-N) along a network path 512. Each of the hops 502 may be a router, a switch, and/or other networking equipment. Unlike conventional devices, hops 502 may be enhanced such that they are configured with the knowledge of their security vulnerabilities (e.g., vulnerability score information). This may include knowledge of existing vulnerabilities in their hardware, software, protocols, etc. and/or knowledge of their vulnerability score (e.g., CVSS score) and/or any other vulnerability information.

In some implementations, any of the hops 502 may be configured to obtain its vulnerability information and/or the vulnerability information of other hops (which it may distribute to the other hopes) from an external source. For example, any of the hops 502 may be configured to obtain their CVSS scores or other vulnerability information directly from a third-party vulnerability assessment website or service (e.g., vulnerability information service 504). For instance, each of the hops 502 may be configured to access an application programming interface (API) of a vulnerability information service 504, such as the national vulnerability database (NVD), common vulnerabilities and exposures (CVE) details, etc. The vulnerability information service 504 may be a website or service that collects, catalogs, and/or exposes known cybersecurity/network vulnerabilities. In another implementation, a network administrator can manually input and/or upload vulnerability score information and/or related data into the hops 502 and/or modifications thereto.

By enhancing the hops 502 such that they are configured with knowledge of their own vulnerability score information, vulnerability metrics can be directly integrated into network traffic management. For example, the hops 502 may be configured to share their vulnerability score information with network traffic management processes such as those described with respect to path visibility process 248. For instance, any of the hops 502 may be configured to enhance their response (e.g., responses 510 (510-1 . . . 510-N)) to path probing communications 514 initiated in association with path visibility process 248. This enhancement may include augmenting its response with the responding hop's vulnerability score information.

For example, a network path 512 may be probed with path probing communications 514. Path probing communications 514 may include path probing packets (e.g., implementing a traceroute process). In various implementations, the probing source (e.g., synthetic probing agent, a node executing the synthetic probing agent, a node sending the synthetic probing packet, etc.) of the path probing communications 514 may be required to be trusted (e.g., known in advance, authorized by the node(s) involved, etc.).

Responses 510 to the path probing communications 514 that include the vulnerability score information may only be returned in instances that they originate from that known trusted node or set of nodes and dropped otherwise. Additionally, or alternatively, the path probe communications 514 themselves may be digitally signed, so that the receiver could verify that they in fact originated from that trusted node or nodes. Involving these types of trust relationship-based conditional communication mechanisms may prevent bad actors from being able to probe a network path for known vulnerabilities which they might then try to exploit.

In some implementations, the path probing communications 514 may include a first packet that is sent along the network path 512 having a time to live (TTL) value of one, a second packet that is sent along the network path 512 having a TTL value of two, a third packet that is sent along the network path 512 having a TTL value of three, and so on. When the first packet reaches the first hop 502-1, the first hop 502-1 may decrement the TTL value to zero. This may trigger the first hop 502-1 to discard the packet and/or send back a TTL header expiry response (e.g., Internet Control Message Protocol (ICMP) TTL expiry, Transmission Control Protocol (TCP) SYN-ACK TTL expiry, etc.) to the probing source.

With respect to the second packet, the first hop 502-1 may decrement the TTL value of the second packet to one before passing it on to a second hop 502-2 that decrements the TTL value of the second packet from one to zero. This may trigger the second hop 502-2 to send back a TTL header expiry response. Likewise, the third packet TTL value may be decremented as it traverses the first hop 502-1 and second hop 502-2 until eventually encountering the third hop 502-N where it is decremented to zero, thereby triggering the third hop 502-N to send back a TTL header expiry response.

Unlike traditional TTL header expiry responses, responses 510 may be enhanced by their corresponding hop with the vulnerability score information of that hop. For example, each hop may embed its vulnerability score information into its TTL header expiry response before transmission. In some instances, the vulnerability score information may be embedded into unused fields of the TTL header expiry response packet. For example, each hop may embed its vulnerability score information in an unused field of an ICMP time exceeded message being returned to a source.

In various implementations, the TTL header expiry response may include a packet including various fields such as Type, Code, Checksum, etc. in accordance with the ICMP protocol. In addition, the packet may include an IP header of the packet that the TTL expired on and/or as much of the first sixty-four bits or eight bytes of the packet that the TTL expired on as can fit within the size strictures for that packet. In such instances, the vulnerability score information may be embedded in the packet such that it consumes a portion of the space for those first sixty-four bits or eight bytes of the packet that the TTL expired on, thereby reducing the amount of that data that can be included in that portion.

The responses 510 (augmented with the vulnerability score information) from each of the hops 502 in the network path 512 may be received at a probing source (e.g., at a synthetic probing agent, at a node executing the synthetic probing agent, at a node sending the synthetic probing packet, etc.) and/or may be ingested by path visibility process 248. Synthetic probing agents may be configured to collect and/or compile vulnerability score information from each of the hops 502 in network path 512 via their corresponding augmented TTL header expiry responses. As such, the vulnerability scores for each of the hops 502 in the network path 512 may be compiled by execution of path visibility process 248. In addition, vulnerability scores of other hops in other routing paths may be compiled, providing insight into hop vulnerability across a variety of potential data paths through a network.

In addition, the responses 510 may be digitally signed. The digital signature may be utilized to verify the source and/or authenticity of the responses 510 as a mechanism to avoid tampering or alteration in transit. In some cases, the inclusion of digital signatures accompanying the responses 510 may exceed the response size available with an ICMP TTL-exceeded response, this latter might require the use of an alternative response method, such as TCP.

In various implementations, a SBOM analysis 506 may be performed for each routing path to assess the security vulnerabilities and risks associated with the software components used in the network paths (e.g., network path 512). SBOM analysis 506 may include an out-of-band SBOM based analysis of each of the hops 502. For example, device information of the hops 502 (e.g., device type, make, model, software version, etc.) may be identified (e.g., by interrogating hops 502, by data communicated from hops 502, by data embedded within responses 510, by referencing external databases, etc.). This device information may be utilized to perform SBOM analysis 506 for each of the hops 502 (e.g., such as through an external SBOM database, SBOM analysis services, etc.). SBOM analysis 506 may reveal SBOM information such as security vulnerabilities and risks associated with the hop based on its characteristics. This SBOM information can be combined with the vulnerability score information to provide a more comprehensive assessment of the vulnerability of each network path.

When executed, path visibility process 248 may utilize the compiled vulnerability score information and/or the SBOM information for hops 502 to produce augmented path visualizations and/or vulnerability informed routing decisions 508. For example, the collected vulnerability score information and/or SBOM information may be fed into a path visualization tool (e.g., ThousandEyes Path Visualization tool), which will now provide a new view displaying vulnerability score information (e.g., vulnerability scores of individual hops in the network path 512). This visualization and/or its underlying data may be utilized by network administrators and/or network management processes in assessing the security risks associated with different network paths and making informed routing decisions. For instance, vulnerability score information can be used to influence routing decisions in the network. For example, network administrators can configure routing protocols to prefer paths with lower vulnerability scores or avoid paths with known high-risk vulnerabilities.

For instance, the vulnerability score information and/or the SBOM information for one or more hops and/or one or more network paths may be compared to preconfigured vulnerability score thresholds and/or to across hops or paths in order to automatically identify a preferred network path (e.g., one with lower vulnerability scores, one with vulnerability scores below a threshold, etc.) and cause data to be routed across that preferred network path. In can be appreciated that, in some instances, this may result in selection and/or routing of data across a network path that may have inferior performance metrics in other aspects as compared to those of another network path, but the selected path may exhibit better vulnerability score metrics (e.g., be less vulnerable and/or more secure) than the path with the better performance metrics.

In various implementations, a particular hop or hops may not be configured (or may not be able to be configured) with the knowledge of their vulnerability score information. However, the devices may still be accessible by a user, such as in an enterprise LAN or WAN environment. In such instances, synthetic probing agents may receive the path trace and IP addresses of the devices in the network path and may determine which devices it can interrogate (e.g., via secure shell (SSH), via and API, etc.).

Then, a probing mechanism may be utilized to query those devices that are able to be interrogated in order to determine device information such as manufacturer, model, OS version, etc. The probing agent may utilize this device information to perform queries via APIs of third-party vulnerability assessment services (e.g., NVD, CVE details, etc.) in order to obtain the CVSS scores and/or other vulnerability information for each device. The probing agent may then enrich the existing path data with any and all nodes vulnerability score information.

As such, architecture 500 operates to facilitate augmentation network path data with vulnerability scores, thereby enhancing network security and decision-making capabilities with respect to routing. Specifically, these techniques obviate the need for API or management-level communication with network devices on an individual basis.

In all, architecture 500 may facilitate a strategic enhancement of routers and switches by imparting them with the knowledge of vulnerability scores. This is achieved by augmenting Internet Protocol (IP) packet Time to Live (TTL) header expiry responses with additional data reflecting the vulnerability score information. Such enhancement allows for an innovative collection of vulnerability data through the deployment of synthetic probes, which are designed to interact with the enhanced TTL header expiry responses and gather the requisite vulnerability information across the network path.

Further refinements may include incorporation of SBOM analysis within routing paths. This enables a deeper understanding of the provenance, composition, and security aspects of software components utilized in network infrastructure, contributing to more informed and secure routing decisions.

Visualization of vulnerability scores is rendered through integration with Path Visualization tools, offering users an intuitive and comprehensive view of the security posture across network paths. The method extends to modifying routing decisions based on the assimilated vulnerability scores, thereby influencing the routing of network traffic in response to perceived vulnerabilities and threats.

Additional aspects of the invention extend the core methodology by including dynamic vulnerability scoring, which leverages real-time threat intelligence feeds to continuously update and refine the vulnerability assessments. Integration with Security Information and Event Management (SIEM) systems is also contemplated, providing for a unified security management framework that facilitates responsive and automated actions against identified vulnerabilities.

In various implementations, architecture 500 may be extended by incorporating machine learning techniques for the detection of anomalies in network traffic patterns, utilizing the collected vulnerability scores as a dataset for the machine learning models to improve the accuracy and timeliness of anomaly detection. Further, risk-based routing is facilitated by architecture 500, where routing decisions are influenced by the associated risk levels of network paths, based on the aggregated vulnerability scores. In doing so, the invention contributes to a strategic reduction of the organization's exposure to potential security breaches.

Moreover, architecture 500 may include a provision for the visualization of an organization's attack surface, which is instrumental in highlighting vulnerable network devices and potential attack vectors, offering a proactive tool for cybersecurity defense. Additionally, architecture 500 may be adaptive to the needs of different organizational security requirements by permitting the customization of vulnerability scoring algorithms and/or thresholds. These algorithms and/or thresholds can be tailored to align with an organization's specific risk tolerance and security policies, ensuring that the vulnerability assessment is both relevant and actionable within the specific context of use.

By leveraging these advancements, the architecture 500 substantially improves network security protocols by providing an intelligent and holistic approach to assessing and responding to vulnerabilities within network infrastructures.

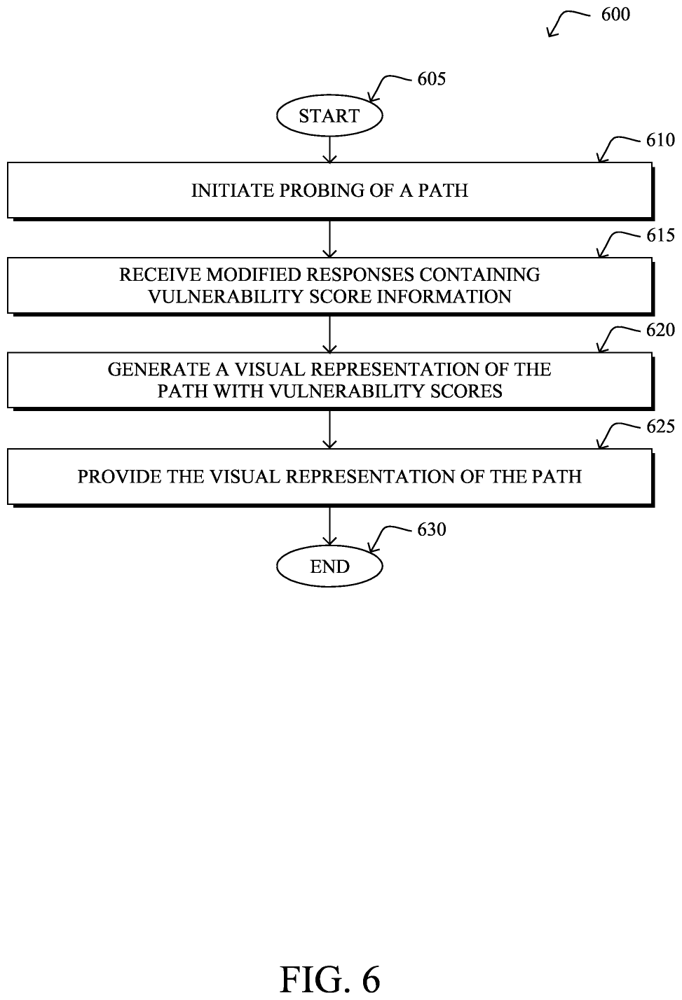

In closing, FIG. 6 illustrates an example simplified procedure for augmentation of network path visualizations with vulnerability information in accordance with one or more implementations described herein. For example, a non-generic, specifically configured device (e.g., device 200) may perform procedure 600 by executing stored instructions (e.g., path visibility process 248). The procedure 600 may start at step 605, and continues to step 610 where, as described in greater detail above, the device may initiate probing of a path in a network by sending one or more probe packets along the path. Each hop along the path may modify its response to a probe packet. For instance, each hop may modify a TTL header expiry to contain vulnerability score information for that hop.

Each hop along the path may modify its response to the TTL header expiry by inserting the vulnerability score information into a time-to-live (TTL) expiry message. The vulnerability score information may be inserted into unused fields and/or inserted such that it abridges the contents of another field in the TTL expiry packet (e.g., an Internet Control Message Protocol (ICMP) packet, a Transmission Control Protocol (TCP) packet, etc.). Each hop along the path may obtain its vulnerability score information via an application programming interface (API).

Initiating the probing of the path may include instructing one or more probing agents in the network to send the one or more probe packets along the path. The probing agents may also be the recipients of and/or be executing on the recipient node of the modified TTL header expiry response.

At step 615, the device may receive modified responses containing the vulnerability score information for each hop along the path. In addition, the device may cause a SBOM analysis to be performed for the path.

At step 620, the device may generate, based on the modified responses, a visual representation of the path that identifies vulnerability scores associated with each hop along the path. In various implementations, the results of the aforementioned SBOM analysis for the path may be incorporated with the vulnerability scores associated with each hop along the path in the visual representation. This incorporation may occur as supplemental data to a vulnerability score and/or as a modification of the variability score. For instance, the vulnerability score may be determined based on variables including the vulnerability score information in the modified responses and/or the results of the SBOM analysis.

At step 625, the device may provide the visual representation to a user interface for display. In addition, the device may cause a routing decision for the network to be made based on the vulnerability scores associated with each hop along the path. This may be an automated routing decision based on analysis of the vulnerability scores as compared to customizable thresholds, the vulnerability scores of other paths, etc. In some instances, the routing decision may be risk-based such that the path along which data is ultimately routed in the path that offers the lowest security risk as quantified by the vulnerability score and/or an acceptably low security risk as balanced against other performance metrics.

In various implementations, the device may dynamically update the vulnerability scores associated with each hop along the path based on a real-time threat intelligence feed. Accordingly, the visual representations and/or routing decisions may be correspondingly updated dynamically. Furthermore, the vulnerability scores associated with each hop along the path may be incorporated with network traffic pattern analysis to detect anomalies in the network.

In some implementations, the device may cause an automated remediation of identified vulnerabilities in the path based on the vulnerability scores associated with each hop along the path. For instance, where the vulnerability scores of a particular hop or path indicate a particular vulnerability or a vulnerability that exceeds some threshold risk metric, automated processes may be implemented to cause that hop or path to remediate this vulnerability. For example, the device may cause devices in the path to install a particular software patch or update designed to ameliorate the vulnerability. Traffic may be routed across lower risk paths until the device receives an indication (e.g., via updated vulnerability score information communications) that the vulnerable path has remediated its vulnerabilities, at which time traffic may be routed back over the remediated path.

In some instances, there may be particular hops in the path that are unable and/or not configured to obtain the vulnerability score information. A determination may be made with respect to these devices whether they can be interrogated via SSH and/or API access. For those devices that are able to be interrogated, their device information (e.g., device manufacturer, model, and OS version) may be queried. Then, any discovered device information for these devices may be used for querying a third-party vulnerability assessment service for vulnerability score information of the particular hop. This vulnerability score information of the particular hop may then be added to the visual representation.

Procedure 600 then ends at step 630.

By augmenting network path data with vulnerability score information and/or incorporating SBOM analysis, this procedure 600 provides a comprehensive assessment of the security risks associated with different network paths. This information can be visualized using path visualization tool and used to make informed routing decisions based on vulnerability scores. This approach can significantly improve the security posture of a network and help protect against potential cyber threats. In addition, this approach gives essential vulnerability insight to network path users that don't own or control the devices that their data is traversing in order to make routing decisions that reflect their data handling and/or security priorities.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

According to the implementations herein, an illustrative method herein may comprise: initiating, by a device, probing of a path in a network by sending one or more probe packets along the path, wherein each hop along the path responds with vulnerability score information for that hop; receiving, at the device, modified responses containing the vulnerability score information for each hop along the path; generating, by the device and based on the modified responses, a visual representation of the path that identifies vulnerability scores associated with each hop along the path; and providing, by the device, the visual representation to a user interface for display.

In one implementation, initiating the probing of the path comprises: instructing one or more probing agents in the network to send the one or more probe packets along the path. In one implementation, the method further comprises: performing a software bill of materials analysis for the path; and incorporating results of the software bill of materials analysis for the path with the vulnerability scores associated with each hop along the path in the visual representation. In one implementation, the method further comprises: causing a routing decision for the network to be made based on the vulnerability scores associated with each hop along the path.

In one implementation, each hop along the path modifies its response to a time-to-live (TTL) header expiry by inserting the vulnerability score information into a TTL expiry message. In one implementation, the method further comprises: dynamically updating the vulnerability scores associated with each hop along the path based on a real-time threat intelligence feed. In one implementation, the method further comprises: causing an automated remediation of identified vulnerabilities in the path based on the vulnerability scores associated with each hop along the path. In one implementation, the method further comprises: incorporating the vulnerability scores associated with each hop along the path with network traffic pattern analysis to detect anomalies in the network. In one implementation, each hop along the path obtains its vulnerability score information via an application programming interface (API). In one implementation, the method further comprises: querying device information of a particular hop in the path that is unable to obtain its vulnerability score information; querying a third-party vulnerability assessment service using the device information for vulnerability score information of the particular hop; and adding the vulnerability score information of the particular hop to the visual representation.

Further, according to the implementations herein an illustrative apparatus herein may comprise: one or more network interfaces to communicate with a network; a processor coupled to the network interfaces and configured to execute one or more processes; and a memory configured to store a process that is executable by the processor, the process, when executed, configured to: initiate probing of a path in a network by sending one or more probe packets along the path, wherein each hop along the path responds with vulnerability score information for that hop; receive modified responses containing the vulnerability score information for each hop along the path; generate, based on the modified responses, a visual representation of the path that identifies vulnerability scores associated with each hop along the path; and provide the visual representation to a user interface for display.

According to the implementations herein, an illustrative tangible, non-transitory, computer-readable medium herein may have computer-executable instructions stored thereon that, when executed by a processor on a computer, may cause the computer to perform a method comprising: initiating, by a device, probing of a path in a network by sending one or more probe packets along the path, wherein each hop along the path responds with vulnerability score information for that hop; receiving, at the device, modified responses containing the vulnerability score information for each hop along the path; generating, by the device and based on the modified responses, a visual representation of the path that identifies vulnerability scores associated with each hop along the path; and providing, by the device, the visual representation to a user interface for display.

While there have been shown and described illustrative implementations that provide for network path probing with vulnerability score information augmentation, it is to be understood that various other adaptations and modifications may be made within the spirit and scope of the implementations herein. For example, while certain implementations are described herein with respect to using certain types of probe protocols and configurations in pre-probe scan and rescan operations, the probes and their usage is not limited as such and may include other protocols and configurations that can be used for other functions, in other implementations.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
initiating, by a device, probing of a path in a network by sending one or more probe packets along the path, wherein each hop along the path responds with vulnerability score information for that hop;
receiving, at the device, modified responses containing the vulnerability score information for each hop along the path;
generating, by the device and based on the modified responses, a visual representation of the path that identifies vulnerability scores associated with each hop along the path; and
providing, by the device, the visual representation to a user interface for display.

2. The method as in claim 1, wherein initiating the probing of the path comprises:
instructing one or more probing agents in the network to send the one or more probe packets along the path.

3. The method as in claim 1, further comprising:
performing a software bill of materials analysis for the path; and
incorporating results of the software bill of materials analysis for the path with the vulnerability scores associated with each hop along the path in the visual representation.

4. The method as in claim 1, further comprising:
causing a routing decision for the network to be made based on the vulnerability scores associated with each hop along the path.

5. The method as in claim 1, wherein each hop along the path modifies its response to a time-to-live (TTL) header expiry by inserting the vulnerability score information into a TTL expiry message.

6. The method as in claim 1, further comprising:
dynamically updating the vulnerability scores associated with each hop along the path based on a real-time threat intelligence feed.

7. The method as in claim 1, further comprising:
causing an automated remediation of identified vulnerabilities in the path based on the vulnerability scores associated with each hop along the path.

8. The method as in claim 1, further comprising:
incorporating the vulnerability scores associated with each hop along the path with network traffic pattern analysis to detect anomalies in the network.

9. The method as in claim 1, wherein each hop along the path obtains its vulnerability score information via an application programming interface (API).

10. The method as in claim 1, further comprising:
querying device information of a particular hop in the path that is unable to obtain its vulnerability score information;
querying a third-party vulnerability assessment service using the device information for vulnerability score information of the particular hop; and
adding the vulnerability score information of the particular hop to the visual representation.

11. An apparatus, comprising:
one or more network interfaces;
a processor coupled to the one or more network interfaces and configured to execute one or more processes; and
a memory configured to store a process that is executable by the processor, the process when executed configured to:
initiate probing of a path in a network by sending one or more probe packets along the path, wherein each hop along the path responds with vulnerability score information for that hop;
receive modified responses containing the vulnerability score information for each hop along the path;
generate, based on the modified responses, a visual representation of the path that identifies vulnerability scores associated with each hop along the path; and
provide the visual representation to a user interface for display.

12. The apparatus of claim 11, wherein the apparatus initiates probing of the path by:
instructing one or more probing agents in the network to send the one or more probe packets along the path.

13. The apparatus of claim 11, wherein the process when executed is further configured to:
perform a software bill of materials analysis for the path; and
incorporate results of the software bill of materials analysis for the path with the vulnerability scores associated with each hop along the path in the visual representation.

14. The apparatus of claim 11, wherein the process when executed is further configured to:
cause a routing decision for the network to be made based on the vulnerability scores associated with each hop along the path.

15. The apparatus of claim 11, wherein each hop along the path modifies its response to a time-to-live (TTL) header expiry by inserting the vulnerability score information into a TTL expiry message.

16. The apparatus of claim 11, wherein the process when executed is further configured to:
dynamically update the vulnerability scores associated with each hop along the path based on a real-time threat intelligence feed.

17. The apparatus of claim 11, wherein the process when executed is further configured to:
cause an automated remediation of identified vulnerabilities in the path based on the vulnerability scores associated with each hop along the path.

18. The apparatus of claim 11, wherein the process when executed is further configured to:
incorporate the vulnerability scores associated with each hop along the path with network traffic pattern analysis to detect anomalies in the network.

19. The apparatus of claim 11, wherein each hop along the path obtains its vulnerability score information via an application programming interface (API).

20. A tangible, non-transitory, computer-readable medium storing program instructions that cause a device to execute a process comprising:
initiating, by a device, probing of a path in a network by sending one or more probe packets along the path, wherein each hop along the path responds with vulnerability score information for that hop;
receiving, at the device, modified responses containing the vulnerability score information for each hop along the path;
generating, by the device and based on the modified responses, a visual representation of the path that identifies vulnerability scores associated with each hop along the path; and
providing, by the device, the visual representation to a user interface for display.
